(19) United States
(12) Patent Application Publication
(10) Pub. No.: US 2025/0317089 A1
(43) Pub. Date: Oct. 9, 2025

(54) Mobile Solar Power Station

(71) Applicants: Erika Bryan, Graham, TX (US); Shawn Bryan, Graham, TX (US); Roger Skidmore, Graham, TX (US)

(72) Inventors: Erika Bryan, Graham, TX (US); Shawn Bryan, Graham, TX (US); Roger Skidmore, Graham, TX (US)

(21) Appl. No.: 18/630,186

(22) Filed: Apr. 9, 2024

(51) Int. Cl. H02S 10/40; H02S 20/20; H02S 30/10; H02S 30/20; H02S 40/38; H02S 50/00

(52) U.S. Cl. CPC H02S 10/40; H02S 20/20; H02S 30/10; H02S 30/20; H02S 40/38; H02S 50/00

(57) ABSTRACT

Mobile Solar Power Station that includes a rigid structure, a frame system, a lift mechanism, an energy harvesting device, and an energy storage device. Each frame within the frame system is equipped with at least one energy harvesting device designed to capture solar energy. The energy collected is stored in a dedicated energy storage device, ensuring its availability for immediate or future use. To maximize energy capture, the station may employ a lift mechanism that enables precise adjustment of the frames' orientation towards optimal sunlight exposure. The operation of this lift mechanism, along with the overall management of the solar power station, is coordinated by an integrated control system.

### FIELD OF THE DISCLOSURE

The present disclosure relates to a mobile solar power station, more specifically a mobile solar generation station that can be easily deployed via a lift mechanism and can be constructed to be used for any need including, but not limited to, an EV charging station, a food bank, and a construction site generator.

### BACKGROUND OF DISCLOSURE

Traditional power generation methods, especially in mobile and outdoor settings, have heavily relied on gasoline or diesel-powered generators. These conventional generators have been the backbone of providing electricity in areas without direct access to the grid or during situations where temporary power is needed. Their widespread use spans across various fields including construction sites, outdoor events, emergency power supply during outages, and remote locations.

Despite their utility, gasoline-powered generators have significant drawbacks. They emit harmful pollutants, including carbon dioxide (CO2), nitrogen oxides (NOx) and particulate matter. The combustion process in these generators also releases greenhouse gases (GHGs). Additionally, the operational costs associated with fuel consumption and maintenance of these generators are considerable. The noise pollution generated by these units is another issue, particularly in residential areas or during quiet outdoor events.

With the increasing awareness of environmental issues and the global push towards sustainable energy sources, there is a growing need for eco-friendly, efficient, and versatile power generation solutions. The transition towards renewable energy sources, like solar power, offers a promising alternative to traditional fossil fuel-based generators.

Solar energy, harnessed through photovoltaic (PV) panels, provides a clean, sustainable, and virtually inexhaustible energy source. Unlike fossil fuels, solar energy does not emit pollutants or GHGs during electricity generation. This characteristic makes it an environmentally friendly option, aligning with global efforts to reduce carbon footprints and combat climate change.

In view of the current state of the art, there remains a need for versatile and environmentally friendly generator system.

### SUMMARY OF THE DISCLOSURE

The present disclosure relates to a mobile solar generation station designed for versatile applications. The present disclosure comprises of a Mobile Solar Power Station that includes a rigid structure comprising of a front side, rear side, first side, second side, top side and bottom side, a frame system including a front, rear, side, and top frame, one or more expansion panels, a lifting mechanism, one or more energy harvesting devices, a control system, and an energy storage device.

In one non-limiting aspect of the disclosure, within the frame system, the front, rear, side and top are secured to the respective surfaces of the rigid structure wherein the front, rear, side are secured to the rigid structure via a hinge mechanism to allow pivotal movement of the frames relative to the rigid structure.

In another non-limiting aspect of the disclosure, the lift mechanism is attached to both the front, rear, and side frames enabling the frames to transition from a stowed to an extended position.

In another non-limiting aspect of the disclosure, expansion panels are attached to the front and rear frames via hinge mechanism allowing them to transition from a folded to unfolded state.

In another non-limiting aspect of the disclosure, each frame and expansion panel support at least one energy harvesting device, which is electrically connected to the energy storage device, establishing a solar energy capture and storage system.

In another non-limiting aspect of the disclosure, the control system interfaces with the lifting mechanism, energy harvesting devices, and energy storage device, enabling user control over the frame positions and the operational state of the energy harvesting devices.

In another non-limiting aspect of the disclosure, the mobile solar generation station can optionally include the capability to remotely monitor and control the Mobile Solar Power Station through an online application interface. The online application enables users to control the control system, facilitating adjustments to the system's settings, scheduling and triggering specific actions. Additionally, the online application could provide the user with real-time data such as charge rate and battery status, as well as system alerts.

In another non-limiting aspect of the disclosure, the lift mechanism optionally includes a hydraulic lift system, an electric motor driven lift system, and a manual lift system.

One non-limiting objective of this disclosure is to provide a mobile solar generation station that can serve multiple purposes, including, but not limited to, EV charging, powering portable kitchens, and providing electricity at work sites. This disclosure aims to replace traditional gasoline generators with a cleaner, more sustainable alternative.

Another non-limiting objective of this disclosure is to provide mobile solar generation station that significantly reduces emissions associated with traditional power generation methods. By utilizing solar energy, the mobile station will contribute to reducing the overall environmental impact, particularly in terms of greenhouse gas emissions and air pollution.

Another non-limiting objective of this disclosure is to provide mobile solar generation stations that offer a cost-effective, low-maintenance alternative to conventional generators. The use of energy harvesting devices reduces the reliance on fossil fuels, decreasing operational costs, and minimizing maintenance requirements.

Another non-limiting objective of this disclosure is to provide mobile solar generation station that is a versatile, user-friendly, and portable solution that can be easily deployed in various settings, catering to the evolving needs of modern power consumption in outdoor and remote locations.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for case of recognition in the drawings. Reference may now be made to the drawings, which illustrate various embodiments that the disclosure may take in physical form and in certain parts and arrangement of parts wherein:

FIG. 1 is an isometric perspective of the mobile solar generation station.

FIG. 2 is a top perspective of the mobile solar generation station.

FIG. 3 is a top perspective of the frame system.

FIG. 4 is a top view of the energy harvesting devices.

FIG. 5 is a front view of the side outer frame.

FIG. 6 is a front view of the front frame and expansion panel(s).

FIG. 7 is a front view of the rear inner and outer frame.

FIG. 8 is a front view of the top inner and outer frame.

FIG. 9 is a close-upside view of a frame in the stowed position.

FIG. 10 is a close-up angled view of the expansion panel bracket.

FIG. 11 is a side view of the outer frame system in the stowed position.

FIG. 12 is a side view of the outer frame system in the extended position.

FIG. 13 is a side view of the side of the rigid structure.

FIG. 14 is a side view of the front of the rigid structure.

FIG. 15 is a side view of an alternative embodiment of frame system in the stowed position with an expansion panel.

FIG. 16 is a top view of an alternative embodiment of the mobile solar power station.

FIG. 17 is a top view of an alternative embodiment of the mobile solar power station.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the case of demonstrating the present disclosure, and are, therefore, not intended to indicate relative size and dimensions of the devices or components thereof or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

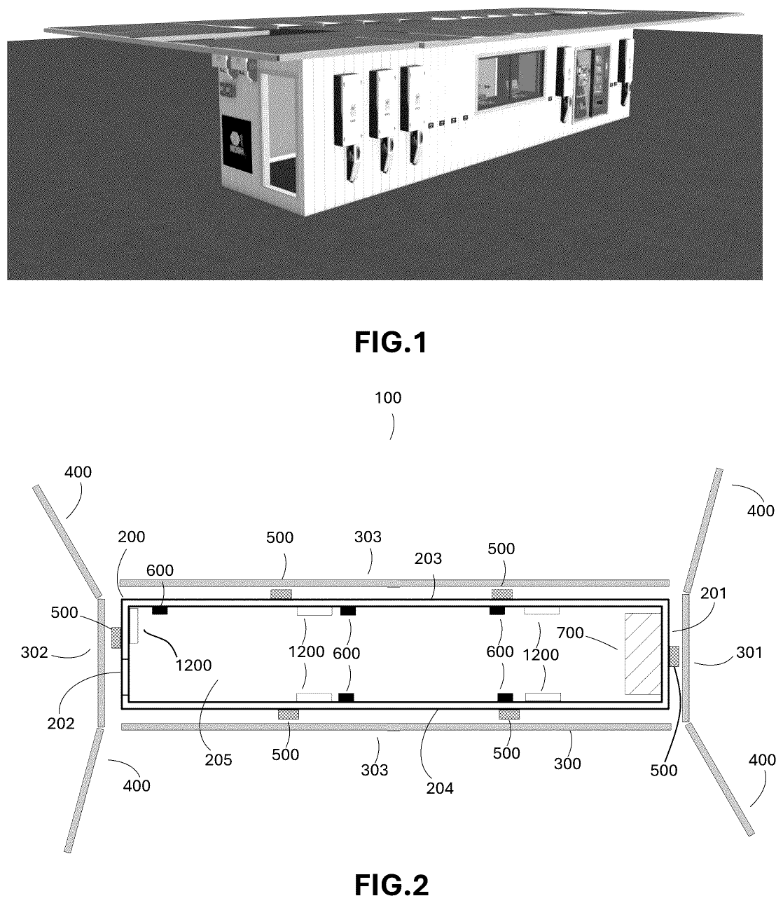

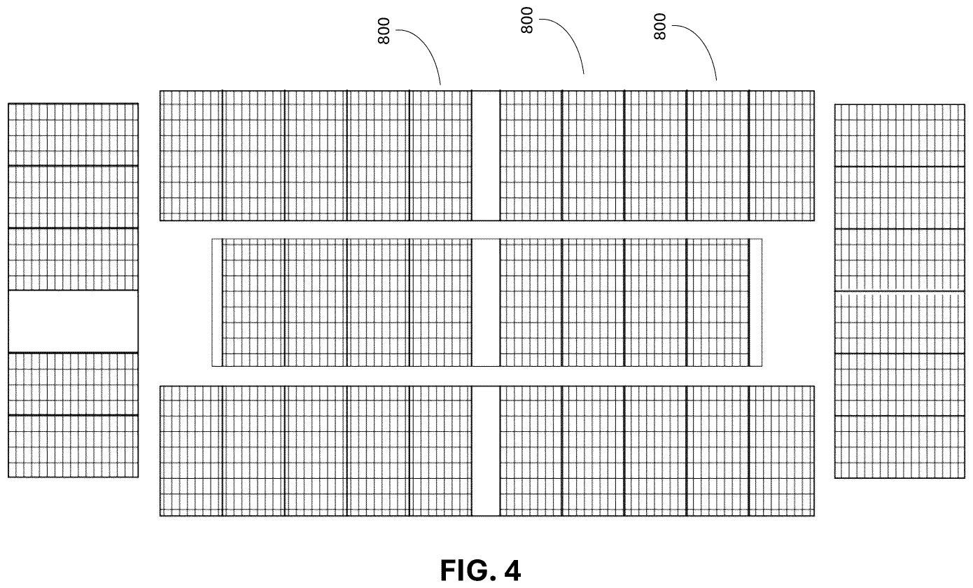

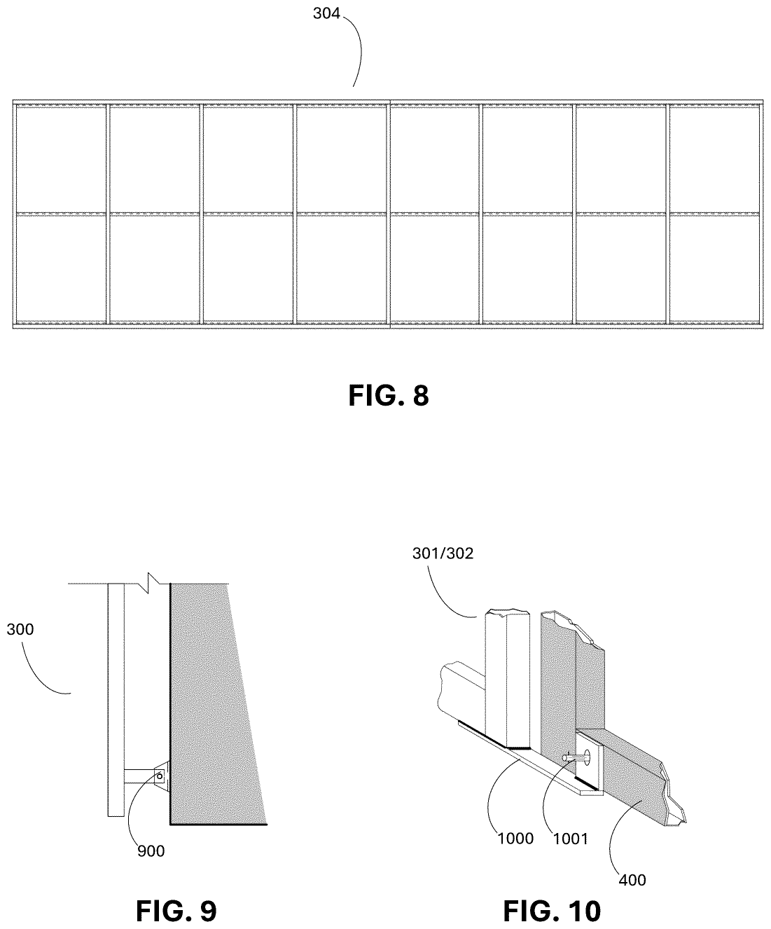

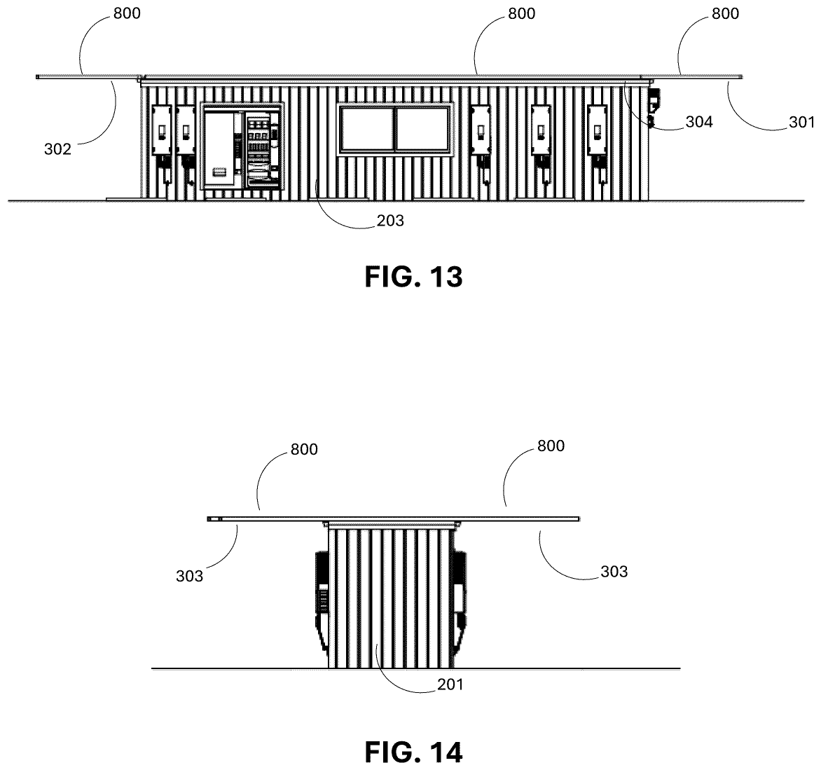

Referring now to the drawings wherein the showings are for the purpose of illustrating non-limiting embodiments of the disclosure only and not for the purpose of limiting same, FIGS. 1-17 illustrate various non-limiting embodiments of the mobile solar power station in accordance with the present disclosure.

FIG. 1 depicts a full view of the mobile solar power station 100.

FIG. 2 depicts a mobile solar power station 100 that may include a rigid structure 200, a frame system 300, at least one expansion panel 400, at least one lift mechanism 500, at least one energy storage device 600, a control system 700, and at least one energy harvesting device 800.

In another non-limiting embodiment, the lift mechanism 500 may comprise of various types of mechanisms including, but not limited to, an electric lift, a manual lift, or a hydraulic lift, each selected to match specific operational requirements and preferences. Additionally, this embodiment may incorporate a hydraulic pump system 1200, enhancing the functionality and efficiency of the lift mechanism, particularly in configurations where hydraulic lifts are employed.

FIGS. 2, 13 and 14 depict rigid structure 200. Rigid structure 200 may include a front side 201, rear side 202, first side 203, second side 204, top side 205, and a bottom side 206.

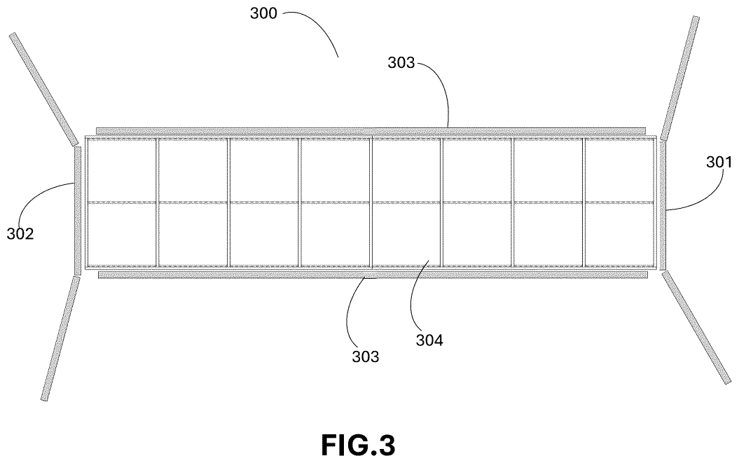

Further, FIGS. 2-3 depict frame system 300 comprising of front frame 301, rear frame 302, side frame 303 and top frame 304. Further, front frame 301, rear frame 302, and side frame 303 are hingedly attached to the respective sides of rigid structure 200 and top frame 304 is attached to the top side 205 of rigid structure 200. It should be appreciated that it is not a requirement that side frame 303 be attached both first side 203 and second side 204 of rigid structure 200, the device can still operate with only one side frame 303 or none at all.

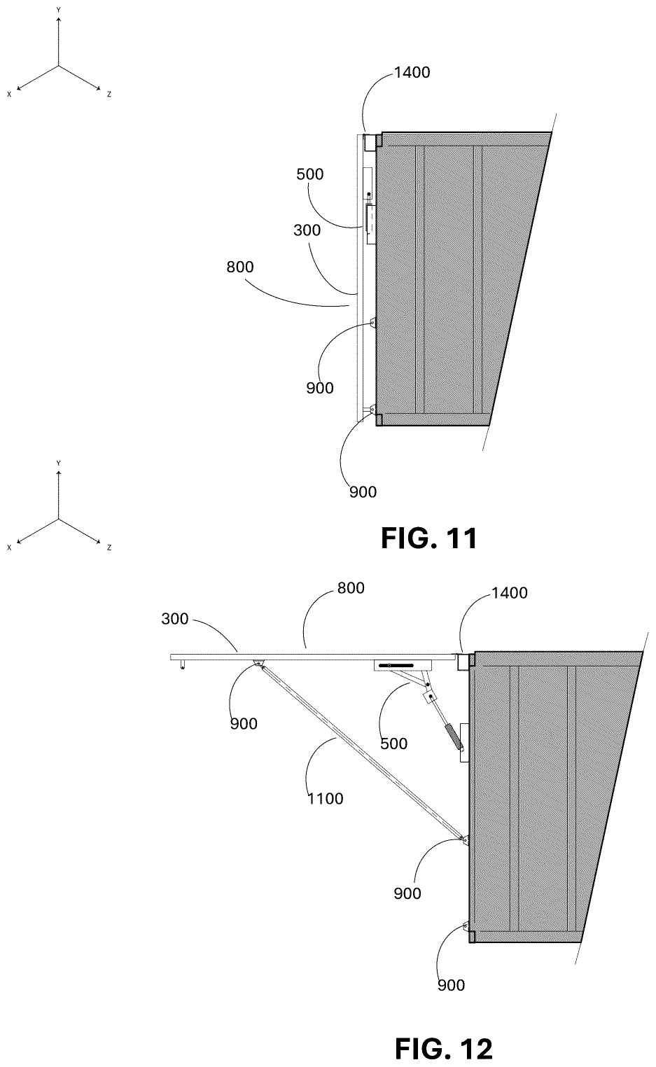

Further as depicted in FIGS. 11 and 12, lift mechanism 500 allows front frame 301, rear frame 302, and at least one side frame 303 to transition between a stowed position, wherein the frames are parallel to the y-axis, and an extended position, wherein the frames deploy at an angle greater than zero degrees relative to the y-axis wherein the y-axis is parallel to the front side 201, rear side 202, first side 203, and second side 204 of rigid structure 200.

In another non-limiting embodiment, top frame 304 may be hingedly attached to the top side 205 of rigid structure 200 to allow top frame 304 to pivot on hinge mechanism 1400. Further, in another non-limiting embodiment, a lift mechanism 500 may be attached to top frame 304.

In another non-limiting embodiment, frame system 300 may include more than one front frame 301, rear frame 302, side frame 303, and top frame 304.

In another non-limiting embodiment, energy storage device 600 may be attached to the front side 201, rear side 202, first side 203, second side 204 and top side 205 of rigid structure 200. Further, the energy storage devices 600 may be hingedly attached to the sides of rigid structure 200 mentioned above.

FIGS. 5-8 depict the frames in frame system 300 including side frame 303 front frame 301, rear frame 302, side frame 303 and top frame 304. Further, front frame 301, rear frame 302, side frame 303 and top frame 304 may include an energy storage device 600.

FIG. 9 depicts a non-limiting alternative embodiment wherein a frame, in frame system 300, is secured in the stowed position by a lock mechanism 900, the lock mechanism 900 comprising any means of securing the frame in a fixed position, including but not limited to a friction fit, a magnetic lock, a clevis lock, a latch system, a bayonet lock, a cam lock, or a quick-release pin.

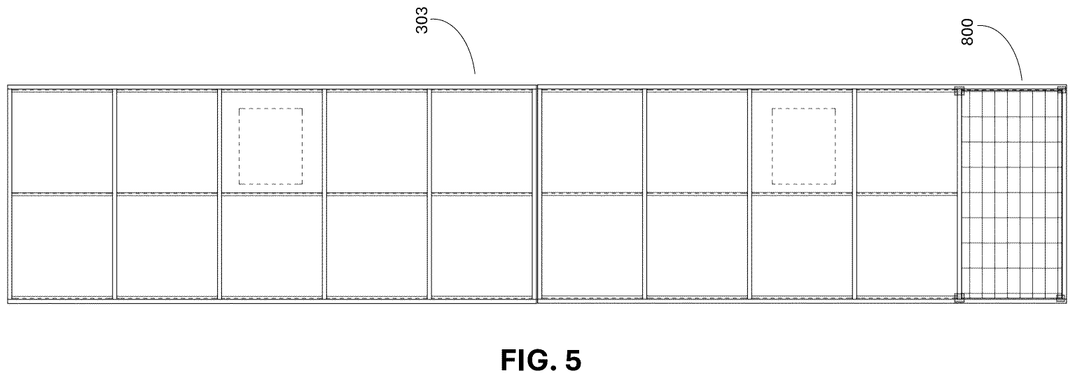

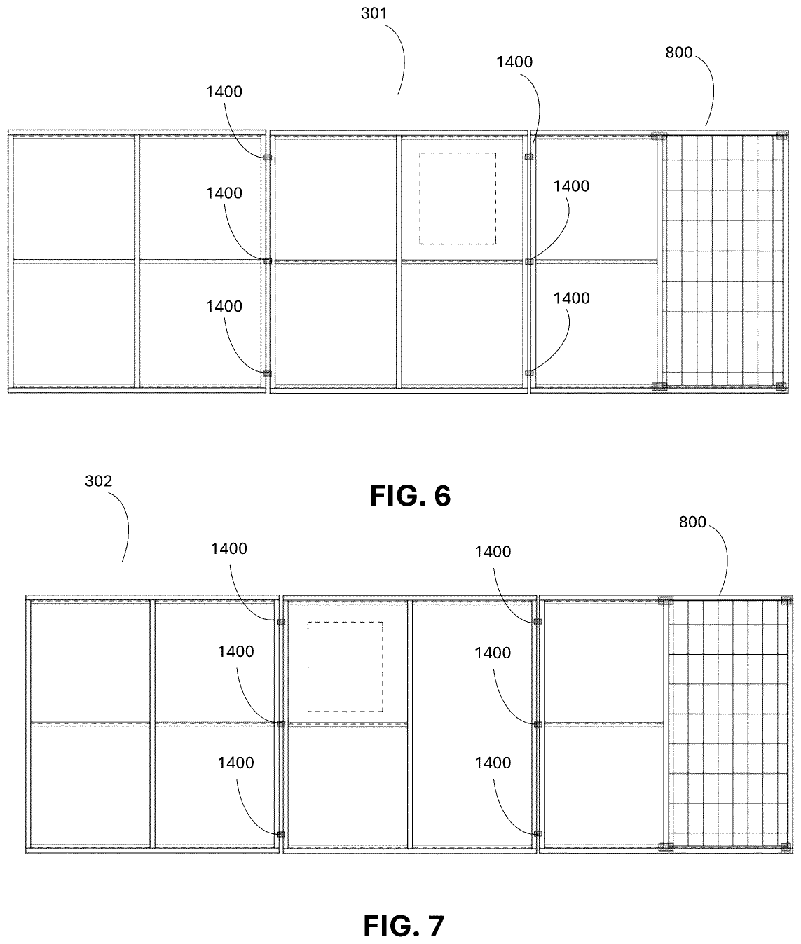

Further, as depicted in FIGS. 2, 5, and 6, at least one expansion panel 400 is attached to the front frame 301 and rear frame 302. As depicted in FIGS. 5 and 6, expansion panel 400 may be hingedly connected to at least one frame, including front frame 301, rear frame 302, via hinge mechanism 1400, or any other frame. Expansion panel 400 may be configured to transition from a folded state, in which it lies substantially flush against the front frame 301 and rear frame 302, to an unfolded state, wherein it extends outwardly to increase the effective surface area of the frame. It should be appreciated that expansion panel 400 is not a required element for mobile solar power station 100 to operate but rather an optional element. Stated another way, expansion panel 400 may be attached to front frame 301, rear frame 302, or both. Further, it should be appreciated that more than one expansion panel 400 may be attached to front frame 301 and 302.

In a further embodiment, expansion panel 400 may be designed to transition between a folded state and an unfolded state via an unfolding mechanism. This unfolding mechanism may consist of a hydraulic actuator, an electric motor, or other suitable mechanical devices capable of providing the necessary movement.

FIG. 10 depicts expansion panel bracket 1000 that locks the expansion panel 400 in place in the folded and unfolded position via expansion panel bracket pin 1001.

In another non-limiting embodiment, expansion panel bracket 1000 may lock in place via a magnetic locking mechanism, friction fit, latch system, or a mechanical catch that ensures the expansion panel remains securely in its desired position, whether folded or unfolded.

FIG. 11 depicts an outer frame, in frame system 300, in the stowed position. Further, as depicted in FIG. 11, when the frames in frame system 300 are in the stowed position, they may be secured to the rigid structure or inner pin system by lock mechanism 900.

FIG. 12 depicts a frame, in frame system 300, in the extended position. Additionally, as depicted in FIG. 12 the system may include support mechanism 1100 connected frame system 300 and rigid structure 200. Support mechanism 1100 could provide stability to the frames in frame system 300 when they are in the deployed position. Support mechanism 1100 may be attached to the system via lock mechanism 900, or any other securing mechanism system.

In another non-limiting embodiment, support mechanism 1100 may be extendable and retractable. Further, support mechanism 1100 may incorporate a hydraulic support system, a spring-loaded system or another comparable mechanism for ease of use.

FIG. 3 depicts energy harvesting device 800. Energy harvesting device 800 will generate power whenever it is in sunlight. Energy harvesting device 800 may be used to provide power to components in the mobile solar power station 100. At least one energy harvesting device may be secured to each of the frames in frame system 300 and each of the expansion panels 400. When the frames in frame system 300 are in the deployed position, the system will increase the effective surface area of the energy harvesting device resulting in more energy generation for the system.

In another non-limiting embodiment, energy harvesting device 800 may comprise of a diverse array of solar panel technologies to suit varying operational needs and environmental conditions including but not limited to polycrystalline solar panels, monocrystalline solar panels, and thin-film solar panels.

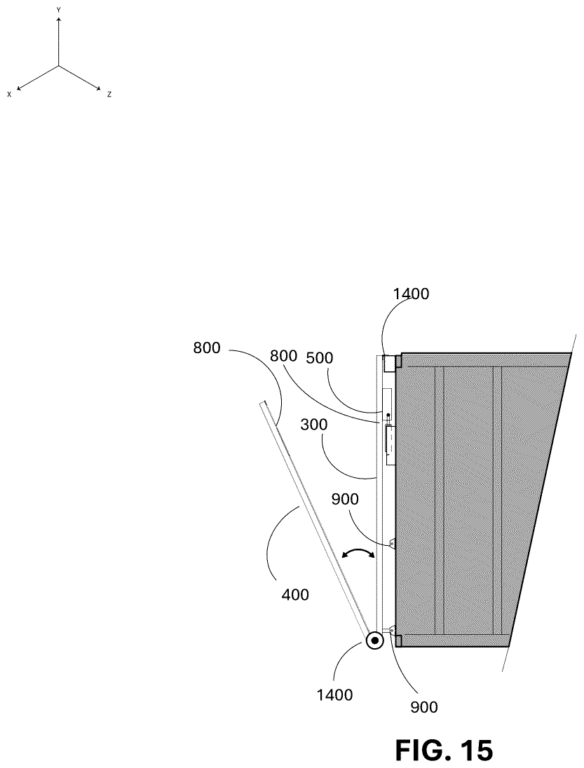

In another non-limiting embodiment as depicted in FIG. 15, the frames in frame system 300 may include an expansion panel 400 attached to the ends of the frames by hinge mechanism 1400 configured to transition expansion panel 400 between a folded and unfolded state. Further as depicted in FIG. 15, expansion panel 400 may have an energy harvesting device 800 attached to the top of it. It should be appreciated that the when in the folded state, expansion panel 400 will provide protection to the energy harvesting devices 800. In another non-limiting embodiment expansion panel 400 may employ a lift mechanism 500 to assist in transitioning it from a folded to an unfolded position. It should be further appreciated that the addition of the expansion panel 400 will increase the affective surface area of the energy harvesting devices 800. In another non-limiting embodiment, another expansion panel 400 could be attached to the end of expansion panel 400, further increasing the affective surface area of harvesting devices 800.

Also depicted in FIG. 2 is control system 700 that may be connected to the energy harvesting device(s) 800, lift mechanism 500, and energy storage device 600. The connection between control system 700 and these components can be accomplished using wired connections, such as electrical cables or data wires. Alternatively, wireless connectivity protocols, including, but not limited to, Wi-Fi, Bluetooth, and Zigbee, c be employed to establish communication links.

In another non-limiting embodiment, control system 700 may be configured for management via an online web application, thereby facilitating enhanced user interaction and oversight. The control system 700 may be engineered to transmit information to the online application in real time, thus ensuring the provision of timely and accurate data to the user. Such data could encompass a variety of parameters, including sensor outputs, ambient environmental conditions, operational status of the device, and additional metrics of relevance. Data acquisition and processing within the system could be accomplished through the integration of various sensors, including, but not limited to, thermal sensors and moisture sensors, among others relevant to the application's requirements.

The establishment of a connection between control system 700 and the online application could be achieved through the utilization of a communication protocol. This protocol would be designed to ensure the secure and efficient transmission of data packets via a wireless network, thus preserving the confidentiality and integrity of the exchanged information through the deployment of wireless communication technologies including but not limited to, Wi-Fi, Bluetooth, Zigbee, or cellular networks, based on the specific needs of the application and the available infrastructure.

Upon successful connection to the online application, users are afforded access to an interface that is both comprehensive and user-friendly. Accessible through a variety of platforms, including web-based portals and mobile applications, this interface provides a streamlined avenue for the monitoring and operator interface with the control system 700. Features of the interface include the presentation of real-time data, visualization of historical trends, graphical representations, and the customization of dashboards, all tailored to align with the user's specific needs and preferences.

Additionally, the online application would endow users with remote control functionality over control system 700. Through this interface, users are empowered to dispatch commands, alter settings, and initiate actions, all of which are subsequently executed by control system 700. This bidirectional communication facilitates seamless interaction between the user and the system, thereby allowing for the customization and optimization of control system 700 in accordance with user-defined specifications. Moreover, the online application is equipped with features designed to augment the user experience and streamline device management. These features include, but are not limited to, data logging and analytics for the examination of historical data patterns, thereby enabling informed decision-making. Furthermore, the application is capable of integrating alert mechanisms, which are activated to notify the user upon the occurrence of predefined events, or the surpassing of thresholds established by the user.

In another non-limiting embodiment, the disclosure could encompass the integration of a light intensity sensor, designed to interface seamlessly with control system 700 and lift mechanism 500. This sensor may be strategically implemented to continuously monitor ambient light conditions, thereby providing critical data to control system 700. Upon analyzing the data received from the light intensity sensor, control system 700 could be programmed to calculate the optimal angle for energy harvesting device orientation, maximizing energy absorption and efficiency.

The light intensity sensor's primary function within this configuration would be to ensure that energy harvesting device(s) 800 are always positioned to receive the maximum possible sunlight exposure throughout the day. This could be achieved by adjusting the energy harvesting devices' 800 angle in response to changes in sunlight intensity, which are accurately detected by the sensor. The adjustment process could be automated through precise control commands issued by control system 700 to lift mechanism 500, which physically repositions the energy harvesting device(s) 800.

This embodiment could leverage algorithms within control system 700 to interpret the light intensity data and determine the most efficient energy harvesting device orientation. The algorithms consider various factors, including the time of day, geographic location, and seasonal variations in sun position, to optimize the angle of the energy harvesting devices. This proactive adjustment strategy could significantly enhance the overall energy generation efficiency of the energy harvesting devices, ensuring that the system operates at peak performance regardless of external conditions.

In another non-limiting embodiment, control system 700 may be programmed to monitor the output efficiency of each energy harvesting device 800 within the array. It compares the performance of each panel to others in the array, identifying panels that show a decrease in efficiency, which may indicate a need for cleaning or repair. When control system 700 detects a panel with significantly lower efficiency, it automatically generates and sends an alert notification. This mechanism prompts timely maintenance for issues such as accumulation of dirt or physical damage, ensuring the panel's performance is optimized. By monitoring and alerting for maintenance needs, this embodiment keeps the energy harvesting device array operating efficiently, reducing downtime and enhancing energy production.

In another non-limiting embodiment, the control system 700 and energy storage device 600 may be specifically configured to cater to high-energy consumption scenarios, enabling the apparatus to efficiently supply power to tasks that require significant energy output. This includes, but is not limited to applications, including EV charging stations, mobile medical offices, mobile convenience stores, mobile restaurants, mobile storage facilities, or power generation stations for high-energy-demand tasks such as work sites, concerts, fairgrounds, etc. Control system 700 may be adept at managing the distribution of stored energy, ensuring optimal power delivery to meet the demands of these intensive uses without compromising the system's performance or efficiency. Furthermore, the energy storage device 600 may be designed to hold a substantial energy reserve, capable of sustaining prolonged high-energy output. This configuration allows for a versatile application of the portable power generation apparatus, making it an invaluable resource for various settings where access to reliable and robust power sources is critical. Through intelligent energy management and substantial storage capacity, this embodiment ensures that the apparatus can meet the rigorous demands of high-energy drawing situations, providing a dependable power solution for a wide range of needs.

In another non-limiting embodiment, the energy storage device 600 may comprise a selection of energy storage technologies including, but not limited to, lithium-ion batteries, nickel-metal hydride batteries, solid-state batteries, and capacitors.

In another non-limiting embodiment, mobile solar power station 100 may incorporate a weather detection system capable of identifying adverse conditions, such as hail, and automatically retracting the frames within frame system 300 to safeguard the energy harvesting devices 800 against harsh weather. Additionally, a protective cover could be deployed to further shield the energy harvesting devices 800 attached to the top frame 304, ensuring their integrity and functionality are maintained despite environmental challenges. This embodiment enhances the resilience and durability of the solar power station, providing an automated response mechanism to protect critical components from damage.

In another non-limiting embodiment, mobile solar power station 100 may incorporate an energy management system designed to optimize power generation, storage, and distribution based on dynamic power demand, predictive weather analysis, and battery status.

In another non-limiting embodiment, mobile solar power station 100 may integrate a water purification system.

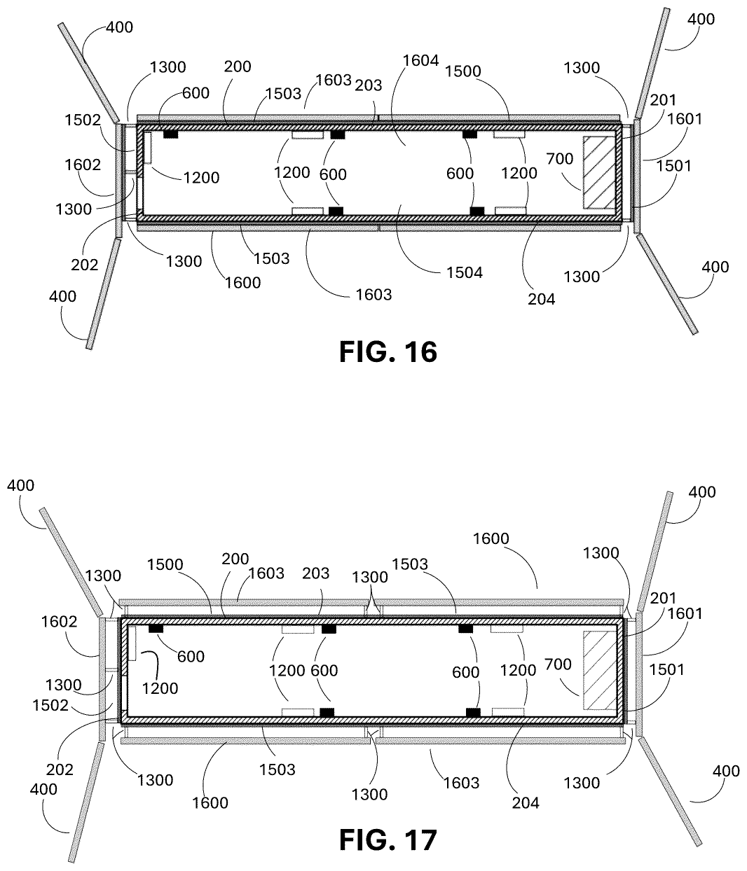

FIG. 16 depicts a non-limiting embodiment of mobile solar power station 100 similar as described in FIGS. 1-14. FIG. 16 depicts a mobile solar power station 100 that may include a rigid structure 200, an inner frame system 1500, an outer frame system 1600, at least one lift mechanism 500, at least one energy storage device 600, a control system 700, and at least one energy harvesting device 800.

Further, as depicted in FIG. 16, inner frame system 1500 may include a front inner frame 1501, a rear inner frame 1502, at least one side inner frame 1503, and a top inner frame 1504. Further, as depicted in FIG. 16, outer frame system 1600 may include a front outer frame 1601, a rear outer frame 1602, at least one side outer frame 1603, and a top outer frame 1604. Further, as depicted in FIG. 16, front outer frame 1601 may be attached to rear inner frame 1502. Front outer frame 1601 may be hingedly attached to rear inner frame 1502 via hinge mechanism 1400. Further, FIG. 16 depicts at least one expansion panel 400 attached to front outer frame 1601. Further, as depicted in FIG. 16, front inner frame 1501 may be attached to rigid structure via extension bar 1300.

Further, as depicted in FIG. 16, rear outer frame 1602 may be attached to rear inner frame 1502. Rear outer frame 1602 may be hingedly attached to rear inner frame 1502 via hinge mechanism 1400. Further, FIG. 16 depicts at least one expansion panel 400 attached to front outer frame 1601. Further, rear inner frame 1502 may have an extension bar 1300 attached to it to use to attach to rigid structure 200.

As shown in FIG. 16, side outer frame 1603 may be attached to side outer frame 1603. Further, side outer frame 1603 may be attached to side inner frame 1503 via hinge mechanism 1400.

In another non-limiting embodiment, there may be more than one side inner frame 1503 and side outer frame 1603.

In another non-limiting embodiment, side inner frame 1503 may be attached to rigid structure 200 vis extension bar 1300.

Further, as shown in FIG. 16, top outer frame 1604 may be attached to top inner frame 1504.

Further, in another non-limiting embodiment, top inner frame 1504 may be attached to rigid structure 200 via extension bar 1300.

In another non-limiting embodiment, top outer frame 1604 may be attached to top inner frame 1504 via hinge mechanism 1400.

In another non-limiting embodiment, top inner frame 1504 may be attached to rigid structure 200 via extension bar 1300.

Extension bar 1300 may be used to attach the frames in inner frame system 1500 to rigid structure 200, creating a space between the inner frames of inner frame system 1500 and rigid structure 200, allowing for the components in the system such as lift mechanism 500 to be mounted to rigid structure 200 without obstructing the movement of outer frame system 1600.

In another non-limiting embodiment, extension bar 1300 may be extendable and retractable or removable to allow better access to the components attached to rigid structure 200.

One or more energy harvesting devices 800 may be attached to the front outer frame 1601, rear outer frame 1602, side outer frame 1603, top outer frame 1604 and expansion panel 400.

Further, a lift mechanism 500 may be attached to front outer frame 1601, rear outer frame 1602, and side outer frame 1603, to be used to transition the aforementioned outer frames from the stowed position to the extended position.

Further, FIG. 17 depicts another non-limiting embodiment of mobile solar power station 100 similar as described in FIG. 16, wherein the frames of outer frame system 1600 are attached to the frames of inner frame system 1500 via extension bar 1300.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

### A Legend of Components Discussed Herein Follows:

Mobile Solar Power Station 100
Rigid Structure 200
Front Side 201
Rear Side 202
First Side 203
Second Side 204
Top Side 205
Bottom Side 206
Frame System 300
Front Frame 301
Rear Frame 302
Side Frame 303
Top Frame 304
Expansion Panel 400
Lift Mechanism 500
Energy Storage Device 600
Control System 700
Energy Harvesting Device 800
Lock Mechanism 900
Expansion Panel Bracket 1000
Expansion Panel Bracket Pin 1001
Support Mechanism 1100
Hydraulic Pump System 1200
Extension Bar 1300
Hinge Mechanism 1400
Inner Frame System 1500
Front Inner Frame 1501
Rear Inner Frame 1502
Side Inner Frame 1503
Top Inner Frame 1504
Outer Frame System 1600
Front Outer Frame 1601
Rear Outer Frame 1602
Side Outer Frame 1603
Top Outer Frame 1604

1. An apparatus for solar power generation, the apparatus comprising:
a rigid structure including a front side, rear side, first side, second side, top side, and bottom side;
a frame system including a front frame, a rear frame, at least one side frame, and a top frame;
a lift mechanism; and
at least one energy harvesting device attached to at least one frame of the frame system,
wherein the top frame is secured to the top side of the rigid structure and the front, rear and at least one side frame is hingedly attached to the corresponding sides of the rigid structure,
wherein the front frame, rear frame, and at least one side frame are each configured to transition between a stowed position and extended position,
wherein the frames are parallel to a y-axis in the stowed position, wherein the y-axis is parallel to the front, rear, first side, and second side of the rigid structure, and
wherein the frames of the frame system deploy to an angle greater than zero degrees relative to the y-axis in the extended position.

2. The apparatus of claim 1, further comprising expansion panels coupled to the front and rear frames by respective hinges, wherein each expansion panel is configurable to transition from a folded state in which it lies substantially flush against the front frames, rear frames, or both front and rear frames, to an unfolded state wherein it extends outwardly; and
locking mechanisms associated with the expansion panels to selectively secure them in either the folded or unfolded state.

3. The apparatus of claim 1, wherein the rigid structure is an intermodal container.

4. The apparatus of claim 1, wherein the locking mechanisms are each associated with the expansion panels includes a clevis fastener.

5. The apparatus of claim 1, further comprising a lifting mechanism, wherein the front, rear, and side frames are configured to transition between a stowed position and extended position using the lifting mechanism.

6. The apparatus of claim 1, further comprising a support mechanism secured to the front, rear, and side frames of the frame system and to the rigid structure to provide support to the frames of frame system when the frames are in the extended position.

7. The apparatus of claim 6, wherein the support mechanism is retractable.

8. The apparatus of claim 1, further comprising an energy storage device.

9. The apparatus claim 5, further comprising a control system.

10. The apparatus of claim 9, wherein the control system interfaces with lifting mechanism, the at least one energy harvesting devices, and the energy storage device.

11. The apparatus of claim 9, wherein the control system is configured to be operable through a software application.

12. The apparatus of claim 9, wherein the control system is configured to perform diagnostic checks of the apparatus and transmit maintenance alerts or diagnostic reports to a user via the software application.

13. The apparatus of claim 9, further comprising at least one environmental sensor integrated with the control system and configured to monitor at least one of temperature, humidity, and light intensity in surroundings of the apparatus to generate sensor data,
wherein the control system is configured to adjust operational parameters of the apparatus based on the sensor data to optimize performance.

14. The apparatus of claim 1, wherein at least one frame of the frame system is coupled to at least one expansion panel.

15. The apparatus of claim 1, wherein each of the frames of the frame system are secured to be stationary relative to the rigid structure by a lock mechanism when in the stowed position.

16. The apparatus of claim 9, wherein the frame system includes an inner frame system and an outer frame system
wherein the inner frame system includes a front inner frame, a rear inner frame, at least one side inner frame, and a top inner frame, wherein each inner frame is securely affixed to the corresponding sides of the rigid structure,
wherein the outer frame system includes a front outer frame, a rear outer frame, at least one side outer frame, and a top outer frame, wherein the front outer frame, a rear outer frame, and at least one side outer frame are hingedly attached to a corresponding inner frame via a hinge mechanism and the top outer frame is attached to the top inner frame,
wherein the front outer frame, rear outer frame, and side outer frame are configured to transition between stowed position, and extended position
wherein the front and rear outer frames are each coupled to at least one expansion panel through respective hinges,
wherein the at least one energy harvesting device is attached to at least one frame on the outer frame system and at least one expansion panel, and
wherein the apparatus further comprises at least one energy storage device housed in the rigid structure along with the at least one control system.

17. The apparatus of claim 16, wherein the width and height of the metal tubing in the inner frame is less than the width and height of the metal tubing in the outer frame.

18. The apparatus of claim 16, wherein all of the inner frames in the inner frame system are secured to the rigid structure via an extension bar.

19. A method for generating power, the method comprising:
providing a mobile solar power generation station that includes a rigid structure including a front side, rear side, first side, second side, top side, and bottom side, a frame system including a front frame, a rear frame, at least one side frame, and a top frame, a lift mechanism, at least one energy harvesting device attached to at least one frame of the frame system, and at least one energy storage device, wherein the top frame is secured to the top side of the rigid structure and the front, rear and at least one side frame is hingedly attached to the corresponding sides of the rigid structure, wherein the front frame, rear frame, and at least one side frame are each configured to transition between a stowed position and extended position, wherein the frames are parallel to a y-axis in the stowed position, wherein the y-axis is parallel to the front, rear, first side, and second side of the rigid structure, and wherein the frames of the frame system deploy to an angle greater than zero degrees relative to the y-axis in the extended position;
deploying the frames of the frame system into the extended position thereby increasing an effective surface area of the solar panels and enhancing the power generation capacity of the station;
storing the energy generated by at least one energy harvesting device in the energy storage device; and
outputting power from the energy storage device to a power consumption device.

20. The method of claim 19, wherein the power consumption device includes one or more of an EV charging station, a home generator, a portable generator, a home power grid, a business power grid, and/or a construction site generator.
